(19) United States
(12) Patent Application Publication
(10) Pub. No.: US 2008/0319811 A1
(43) Pub. Date: Dec. 25, 2008

(54) SYSTEM AND METHOD FOR MODELING AN ASSET-BASED BUSINESS

(76) Inventor: Audrey Lynn Casey, Burnaby (CA)

Correspondence Address: GOWLING LAFLEUR HENDERSON LLP (OTT), SUITE 2600, 160 ELGIN STREET, OTTAWA, ON, K1P1C3, CA

(21) Appl. No.: 11/967,672

(22) Filed: Dec. 31, 2007

Related U.S. Application Data
(60) Provisional application No. 60/945,551, filed on Jun. 21, 2007.

(51) Int. Cl. G06Q 10/00; G06F 17/00

(52) U.S. Cl. 705/7

(57) ABSTRACT

A system for modeling a plurality of assets in a business, the system comprising a database having one or more asset data structures each for storing data representing an asset of the business, the asset having an ascertainable productive output with forecastable market value; and the data structure having one or more attribute values corresponding to the financial and non-financial productive outputs, inputs, and associated impacts of the asset over a time period which relates to the useful productive life of the asset.

### CROSS-REFERENCE TO RELATED APPLICATIONS

This application claims priority from U.S. Provisional application No. 60/945,551 filed Jun. 21, 2007, the disclosure of which is incorporated herein by reference in its entirety.

### FIELD OF THE INVENTION

The present invention relates generally to methods and systems for modeling a plurality of assets in an asset based business and more particularly to asset investment decision optimization which use the model to evaluate different asset investment decisions, termed investment alternatives.

### BACKGROUND OF THE INVENTION

Many asset-based businesses, such as electricity generation facilities, are beginning to face problems with their asset-based infrastructure in that, as their equipment items have a defined life, they must plan for when their equipment items reach the end of their design life. Reliability is becoming an increasing concern. Decisions to repair or to replace are being made, not just on specific equipment items, but on entire facilities. Environmental, safety, and social concerns relating to the overall business also introduce new costs and reporting requirements. For example shareholders, regulators, customers and Boards increasingly want transparent yet rigorous and methodical processes that demonstrate the prudent and careful management of a businesses portfolio of assets. At the same time, long-term sustainability has become a key issue for many executives in asset-intensive businesses. As the focus shifts to sustaining their portfolio of assets, business will require new processes and tools to support strategic asset planning, and to integrate these with budgeting and performance management.

While it is commonly understood that a businesses asset base generally encompasses physical equipment items, in the present description we define an asset base to encompass all the definable elements, associated with a business that can bring value over time to the business i.e. productive assets.

Some tools are available to assist in asset planning are based on models of equipment items which predict the ROI (return on investment) or productive capacity (as a single output of the model) for that equipment item. This type of equipment item model is limited to modeling the impact of that component equipment item on the overall performance of the productive asset in which it is contained. For example, assume a governor represents a component equipment item in a generating station, and the generating station represents the overall productive asset. Assuming that the governor is nearing the end of its useful life and is showing a trend of slipping, typical models evaluate the likelihood and consequence of governor failure, providing an economic evaluation of the component's specific repair versus replacement, while assuming the economics of the generating station—the productive asset it serves—are fixed. This approach does not take into account the long term economic viability of the productive asset—the generating station—in light of risks like changes in the market value for electricity—the productive output of the generating station—and the impacts of different investment scenarios (investment alternatives) for not only the generating station, but also the governor and other components of which the generating station is comprised.

Other tools use historically measured event probabilities to predict the performance and status of the physical assets into the future. An example would be predicting the probability and effect of a negative component event on the output or function of an asset system, such as a component failure on a water distribution system, where such event's effect may be analyzed using Failure Mode Effects Criticality Analysis (FMECA) and where the component failure probability might be based upon component survivor curves or other tools commonly known in operations engineering and analysis. Such tools, while useful in predicting a system's future operation, are of limited use in considering alternative investments in an asset base as they generally address only the supply or cost side of a business, they may not consider the impact of incremental investment on attributes of the asset beyond the probability of component failure such as maintenance cost, consumables usage, etc., and they are limited to applications where the component reliability information is readily available and dependable.

One of the limitations of current models and optimization techniques in the context of asset based businesses is in their objectives or goals. Typically their goals are focused on maximizing impact on the value of a business (as determined for shareholders rather than all stakeholders); eliminating so called pain points in processes; or focusing on evaluating a specific business problem as for example taught in United States patent publication No.s 2007012998 and No. 2007003850.

Another limitation of the currently employed planning models and optimization techniques relates to the limited timeframe often considered and supported. Typical planning models focus and support capital investment budget cycles of one to three years and therefore seek to identify maximum economic impact of a select portfolio of investment alternatives within this time horizon. Each investment listed in the portfolio is assigned a value score. The value score is the result of the investment's impact on a number of business value attributes: financial return, safety impacts, avoided downtime, etc. An investment alternative's impact on each attribute is converted into a common currency such that standard linear programming can be applied to all alternatives to identify those investments that maximize organizational utility. The result is an investment portfolio that maximizes organizational utility over the timeframe of a budget cycle. As these models focus on prioritizing the investment portfolio as it relates to creating business value within the budget cycle, activities and projects which will last beyond the budget cycle are excluded, resulting in sub-optimal asset investment in the longer term. This is especially problematic for capital asset intensive businesses where asset life and productive value can be considered over decades.

A further limitation of current tools is that they assume a fixed market value for a product or service and do not consider such factors as changing market demand for a product or service or the change in market value of the productive output of an asset.

Accordingly there is a need for a system and method which mitigates the above disadvantages and provides a flexible, enterprise-wide tool for modeling and analyzing investment alternatives which revolve around a company's asset base, while simultaneously considering these investment alternatives within a dynamic market environment.

### SUMMARY OF THE INVENTION

An advantage of the present invention is to provide a computer based system and method for modelling a plurality of assets in an asset based business which takes into account different market demands for products and services produced by the assets over many years into the future.

A further advantage of the invention is to provide a computer based system and method that makes use of the computer based model to allow a user to select, display and compare different investment alternatives.

In accordance with a first aspect of this invention there is provided a system for modeling a plurality of assets in a business, the system comprising:
(a) a database having one or more asset data structures each for storing data representing an asset of the business, the asset having an ascertainable productive output with forecastable market value; and
(b) an attribute data structure associated with each asset data structure for storing one or more attribute values corresponding to the financial and non-financial productive outputs, inputs, and associated impacts of the asset over a time period which relates to the useful productive life of the asset.

In a further embodiment the asset data structure includes a hierarchy of similarly described components which comprise the asset wherein the market value of the productive output of the asset's components may not be ascertainable and predictable by themselves.

In a still further embodiment of the current invention there is provided a system of modules, libraries and databases utilizing the component data structure which allows for modeling the assets of a business and evaluating investment alternatives in those assets wherein the market environment for the productive output of those assets may change over time.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 is an Entity Relationship Diagram (ERD) of a planning tool according to the prior art;

FIG. 2 is a process diagram for conceptualizing factors related to creating an Asset Planning System, according to an embodiment of the present invention;

FIG. 3 is an ERD of the Asset Planning System according to an embodiment of the present invention.

FIG. 4 is an Asset Base Model according to the present invention;

FIG. 5 is an ERD of the Asset Base Model show spending and impact attributes of a single Investment Alternative associated with an asset or component;

FIG. 6 shows a data screen of the present invention which supports the population and review of data for an asset Investment Alternative;

FIG. 7 is a process diagram for populating the Asset Base Model of the current invention and using it and the associated Asset Planning System elements to consider Investment Alternative and decide upon the preferred alternative between term;

FIG. 8 is a sample data record;

FIG. 9 is a system for implementing the asset planning system according to an embodiment of the invention; and

FIG. 10 is a screen display associated with an asset base model for inputting and display an equipment hierarchy;

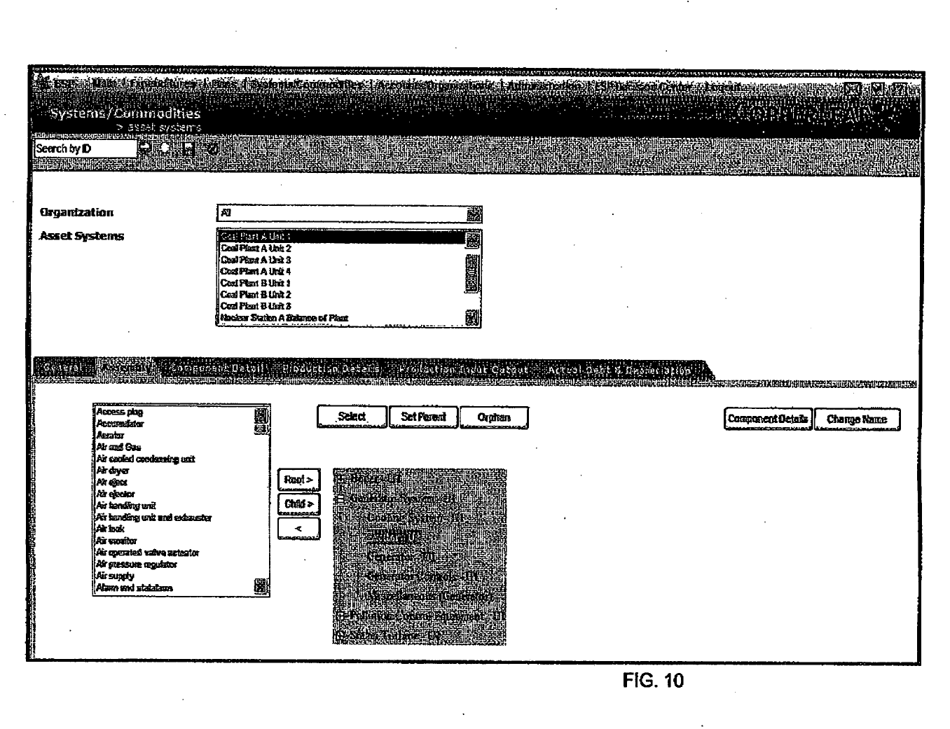

FIG. 11 is a screen display for inputting and displaying an attribute of an asset in the equipment hierarchy;

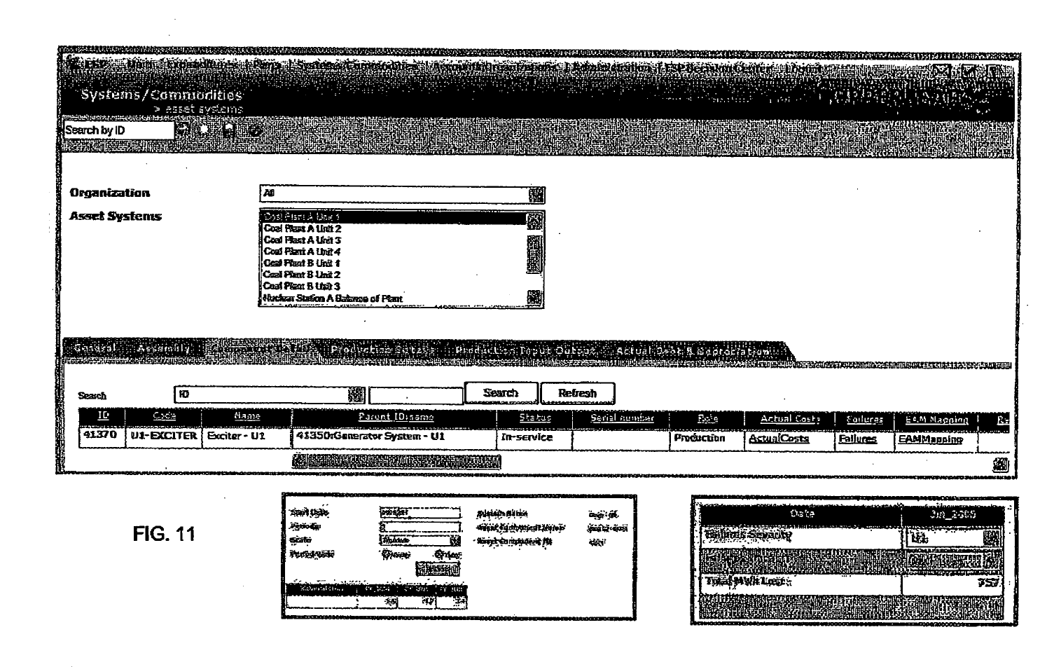

FIG. 12 is a screen display for inputting and displaying an organizational hierarchy;

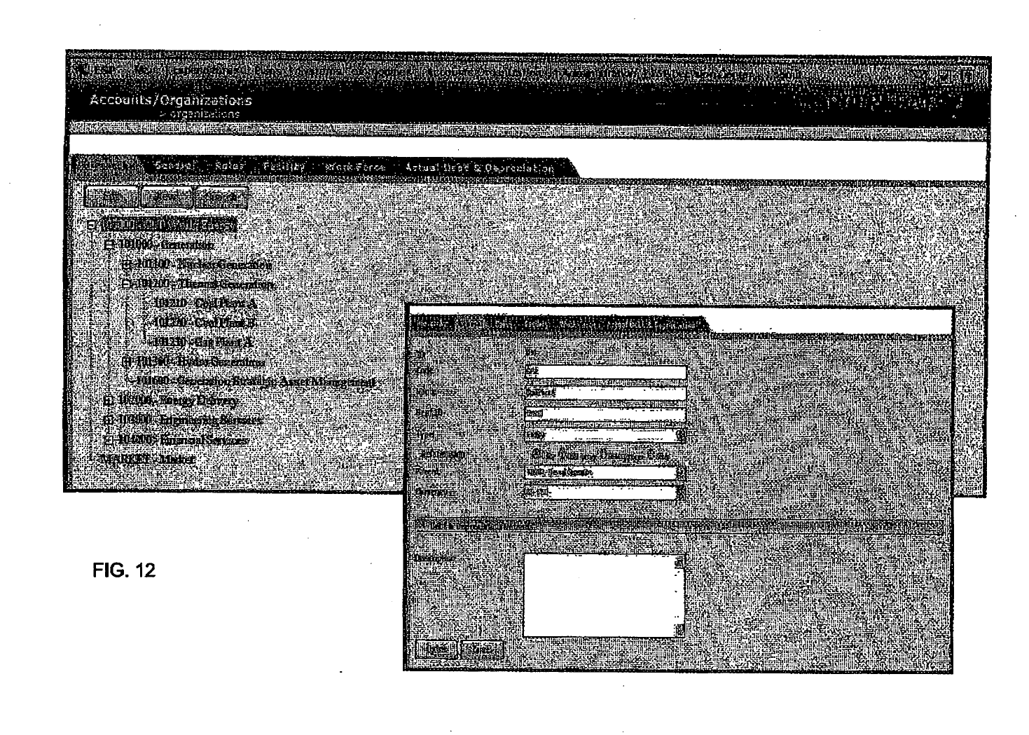

FIG. 13 is a screen display for inputting and displaying economic assumptions and indicators;

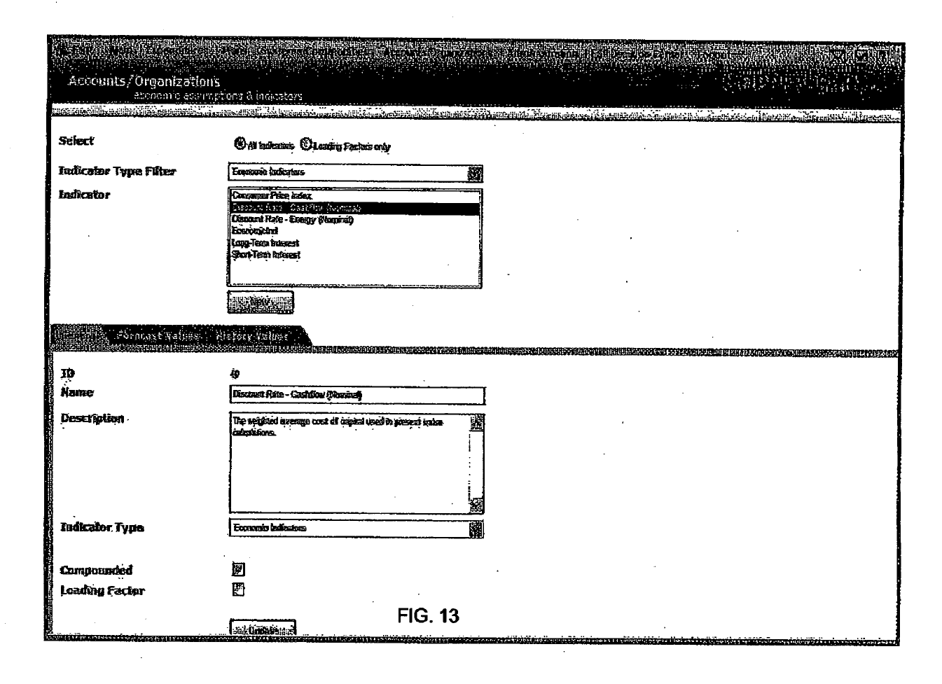

FIG. 14 is a screen display for inputting and displaying output commodities of a business;

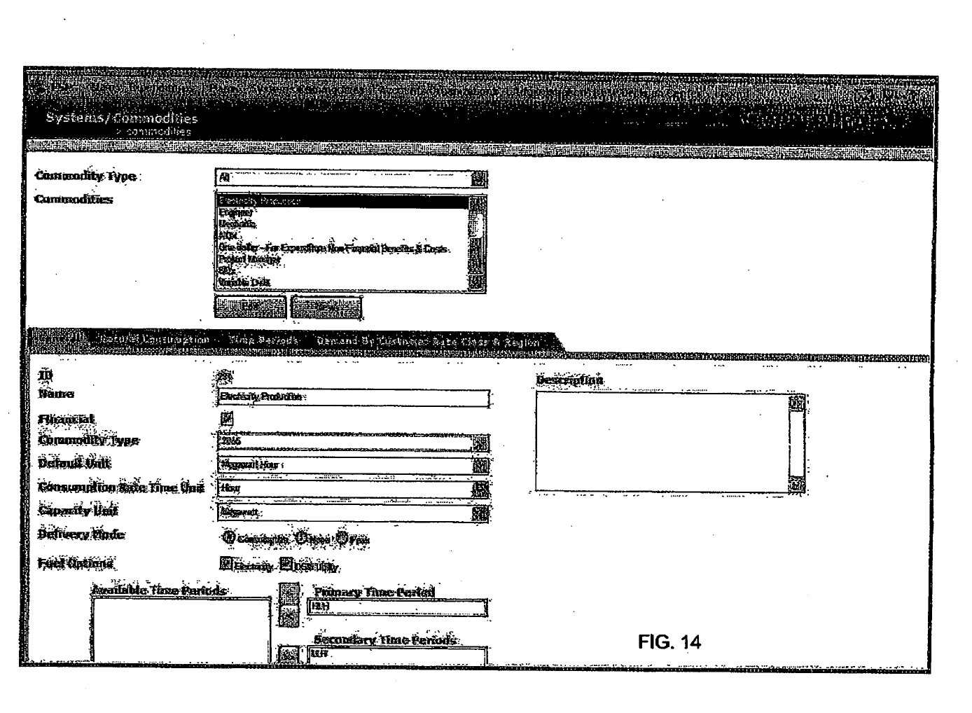

FIG. 15 is a screen display for inputting and displaying commodity pricing over one or more time periods;

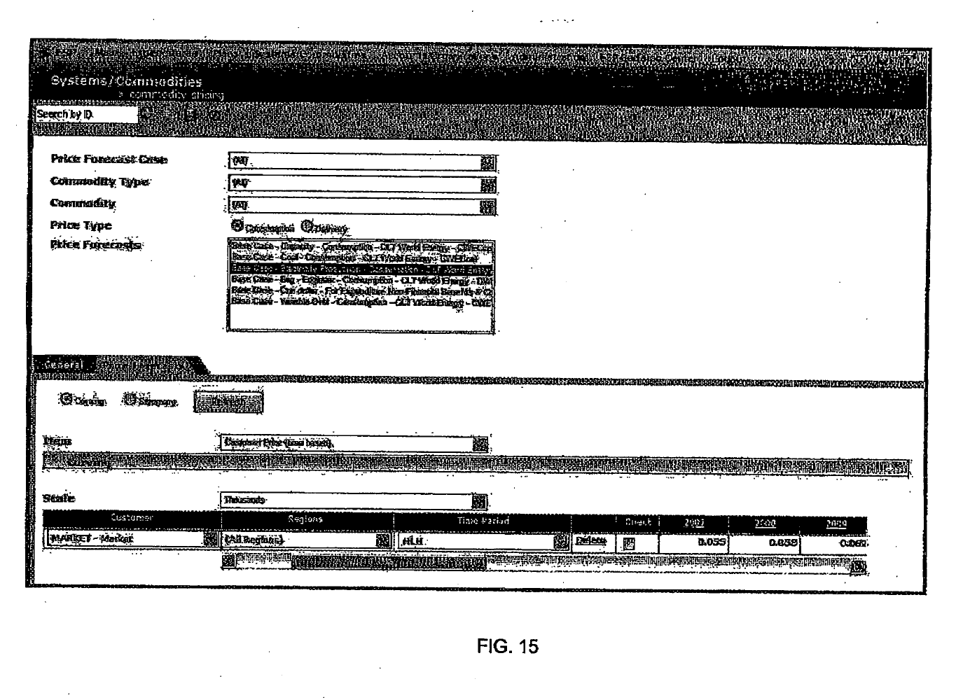

FIG. 16 is a screen display financial report generation;

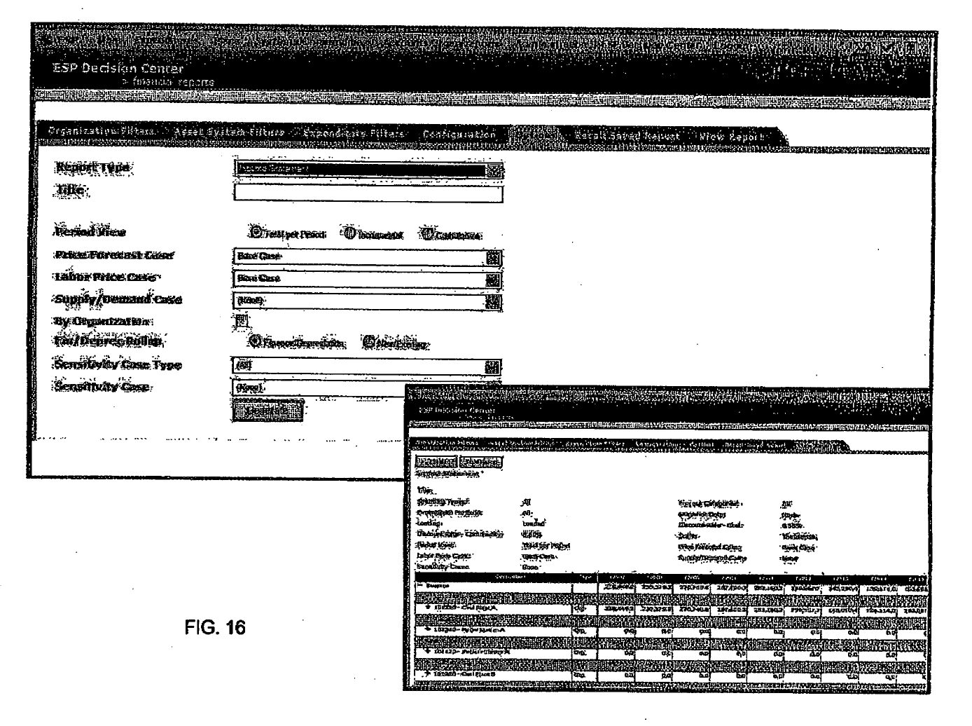

FIG. 17 is a screen display crating and optimizing budgets according to an embodiment of the present invention;

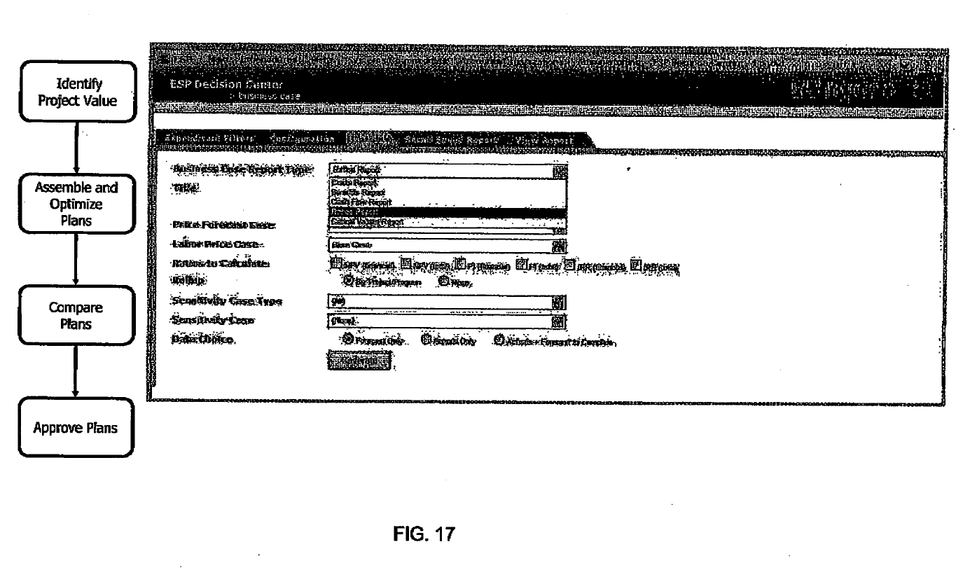

FIG. 18 is a screen display show a comparison of investment alternatives according to an embodiment of the present invention; and

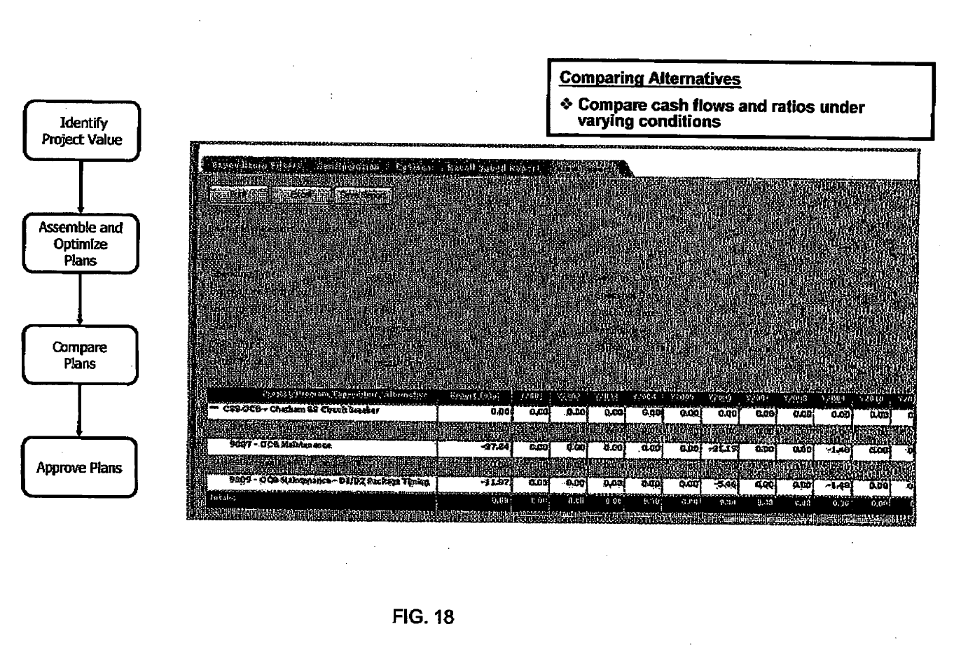

FIG. 19 is a screen display showing a valuing of a portfolio of investment alternatives according to an embodiment of the present invention.

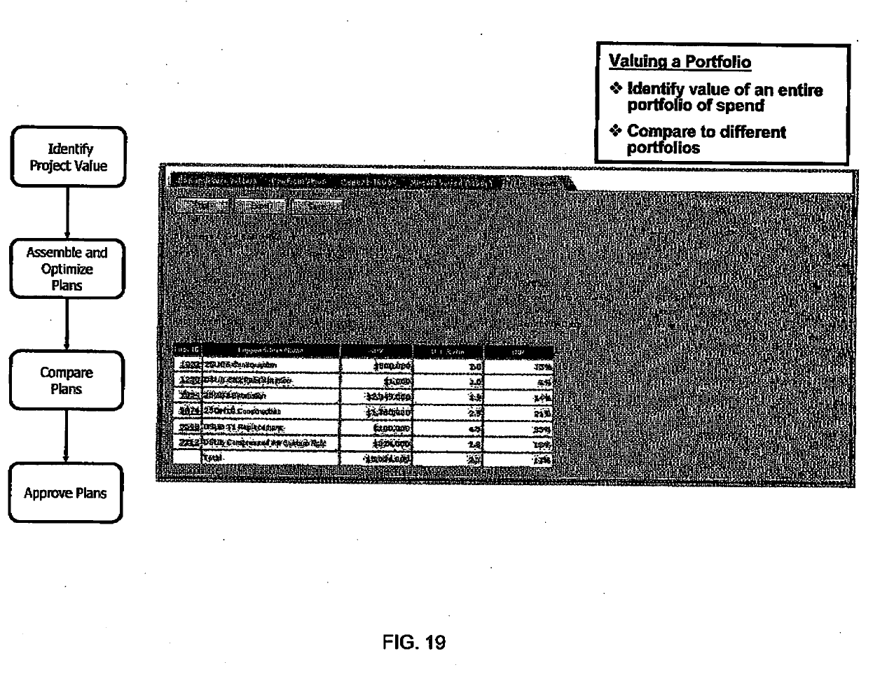

### DETAILED DESCRIPTION OF PREFERRED EMBODIMENTS

In the following description like numerals refer to like structures in the drawings.

The present invention relates generally to an asset investment planning approach that captures and uses market information related to projected customer demand, safety, environmental and regulatory requirements, with engineering information related to asset condition, capacity, reliability, and maintenance requirements, and financial information related to market pricing, debt, long-term value, and return obligations.

An advantage of the present approach is that incorporating effective asset-based planning into the enterprise planning processes aids the optimal allocation of spending to enhance value and manage risks. It also increases the levels of rigor and consistency in planning processes, thereby improving stakeholder confidence in plans as well as supporting effective governance and transparency.

Asset investment planning requires an understanding of the aspects of productive capability and “health” of existing assets relative to business objectives, asset intent, risk tolerances, and societal, regulatory and market conditions

To effectively optimize investments, a model of the business must be derived which allows capture of appropriate data to support decisions about assets made both within a business' shorter term budget cycle and over the full term of an asset's life.

In order to effectively model a business' asset base into the future, the model must take into account that assets need to be retired and depreciated over time at a rate and profile which matches the actual decline in value of each asset. As each asset may have a different depreciation profile and rate, a system which individually reflects each asset's unique situation and alternatives is advantageous rather than pooling a class of assets together and depreciating this pool as a single entity as is conventional within systems used for financial accounting.

It is especially advantageous in the asset planning process to be able to treat each asset separately with alternative specific and modifiable retirement and depreciation profiles and rates. This requires various and varying combinational scenarios of asset investments, refurbishment and retirement to be projected and considered wherein each decision in each scenario will change the individual and cumulative depreciation projections. While the above describes asset depreciation as a specific attribute of the asset, the principal is generally true of any asset attribute including but not limited to productive output, productive capacity, reliability, environmental impact, etc.

Thus a benefit of the current invention over traditional financial transaction-based planning systems is that each asset is considered and planned for individually rather than pooling the attributes—such as deprecation—of a company's assets into general ledger account codes and thereby losing the important asset-specific information required for considering alternative asset investment scenarios.

To sustain the value generation capability of a business into the future, an investment portfolio of investment alternatives into its asset base must occur over time. The question that needs to be answered from an investment planning perspective is how much investment is needed, and at what point in time, with the goal of investment to provide a balance between cost, risk tolerances and performance requirements the businesses' stakeholders find acceptable. To address this question, the present invention provides a system and method to address modeling the business, as composed of its market environment, its asset base and its investment portfolio, while enabling real-time reporting and analytics from an asset-centric perspective.

To reiterate, in the present context, an asset is anything that can bring value to the business over time and an investment is the expenditure of funds by the company. This expenditure of funds, or spending, can be segmented into standard classes of operating, maintenance, administrative, capital or overhead wherein some of the expenditures will be operationally variable in nature, and vary with the output of the asset, and others will be discrete investment alternatives to be considered. All of these expenditures, be they operational or discrete, can be expected to vary with the health and life of the asset.

Planning encompasses three activities, namely modeling, analyzing, and approving. Modeling refers to a process for constructing a data structure that represents how value of an asset, or more generally an asset system, can be quantified and monetized in a varying and uncertain environment. Analyzing refers to the application of the model to determine answers to “what-if” scenarios and conducting analyses of the impacts various scenarios are expected to have on the performance of the organization relative to the business objectives of the business. Approving refers to a process for recommending a decision to the organization based on the reports generated during the analyzing phase.

In addition, asset investment planning systems must increasingly support the “Triple Bottom Line” approach to modeling, analyzing and approving investment scenarios by considering scenario costs and benefits against three factors: social, environmental and financial. The current invention advantageously and optionally supports this new planning approach.

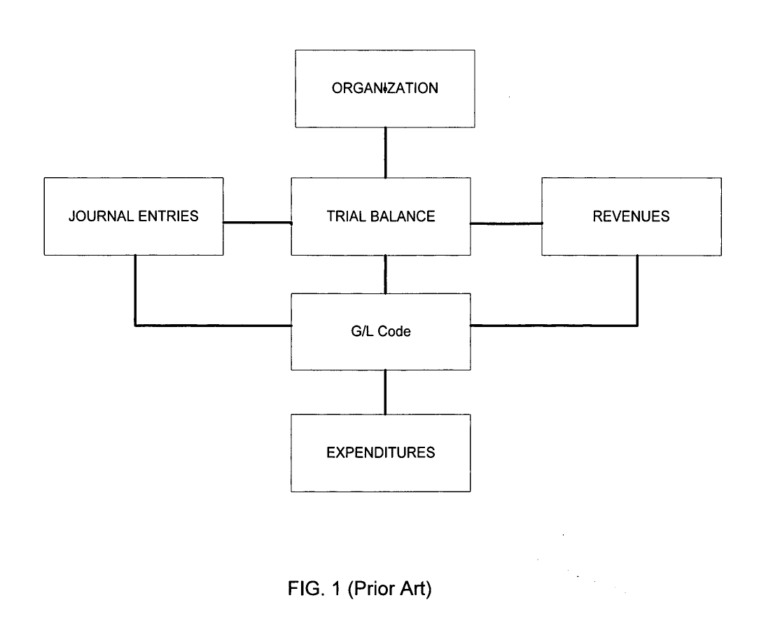

Referring to FIG. 1 there is shown an overview of an entity relationship diagram (ERD) 100 of a prior art planning tool, most commonly used in industry, based upon accounting transaction systems centered around financial accounting general ledger code blocks. The entities include an organizational control hierarchy 102, General ledger code block 104, Expenditures 106, Revenues 108, journal entries 110 and Trial balance 112. The organizational hierarchy 102 represents the hierarchy of cost, revenue, profit and/or investment centers of the business. Data captured within the organizational hierarchy 102 include name, definition, code or reference number, function, region, parent organization. The general ledger code block 104 includes data specifying general ledger account codes, activity codes, and labor classifications (such as mechanics, electricians, managers, analysts, etc). Expenditures 106 includes expenditures which are forecast against accounting codes using standard rates or discrete values across time. Expenditures are stored as real dollars with no facilities for converting to nominal dollars; eliminating the ability to model inflationary or deflationary cost effects over time. Further, these systems do not support analyzing plans relative to the time value of money; they do not support discounted cash flow analysis to identify the present value of future cash flows. Additional shortcomings of this accounting transaction-based method includes an inability to efficiently relate work to asset maintenance activities or capital projects, an inability to efficiently use forecasts from previous years due in part to an inability to convert real/nominal dollar values across years and across many expenditures, lack of flexibility to consider and model expenditures prior to budget approval for that activity or project, and, as a result of these limitations, the requirement to build, analyze and prioritize expenditure forecasts in off-line, disconnected and cumbersome spreadsheets. A further disadvantage of this system is that scenario analysis is often limited to a fixed increase or decrease for a given cost as represented by the general ledger code. For example if a travel expense increases or decreases by 10%, lumping this under a general ledger code provides no insight into how a single expenditure or a group of expenditures, or alternative timing of that single expenditure or group of expenditures, influences a specific asset or the revenues, costs or risk associated with that asset.

Revenues 108 are frequently forecast based on static product sales forecast at a static price. Shortcomings of this method is the inability to analyze revenues based on asset productivity or customer demand and the inability to analyze operating costs (cost of goods sold) based on asset productivity or input commodity prices.

Thus it may be seen that prior art planning tools centered around the general ledger code block 104 are unable to model how a business creates value from its asset base. Reports generated by the prior art planning tool 100 are inadequate for asset investment planning since they are designed to support reporting requirements for capturing accounting transactions (debits and credits) whose core architecture is the general ledger code block 104, consisting as described of information partitioned into organizations, general ledger codes, activity codes and labour rather than into information partitioned by asset. Data stored in such a general ledger code block manner cannot be efficiently aggregated and represented in non-transactional structures, such as but not limited to that useful for asset-centered decisions and planning, nor can planning tools be created that replicate how the asset portfolio creates value for the business into the future nor can it model the business as a collection of assets and their associated attributes including spending and financial and non-financial impacts. Prior art planning tool 100, and the planning method it supports, can not therefore provide insight into the business value of the asset base relative to the life-cycle investment needs given the recommended expenditure plan or portfolio.

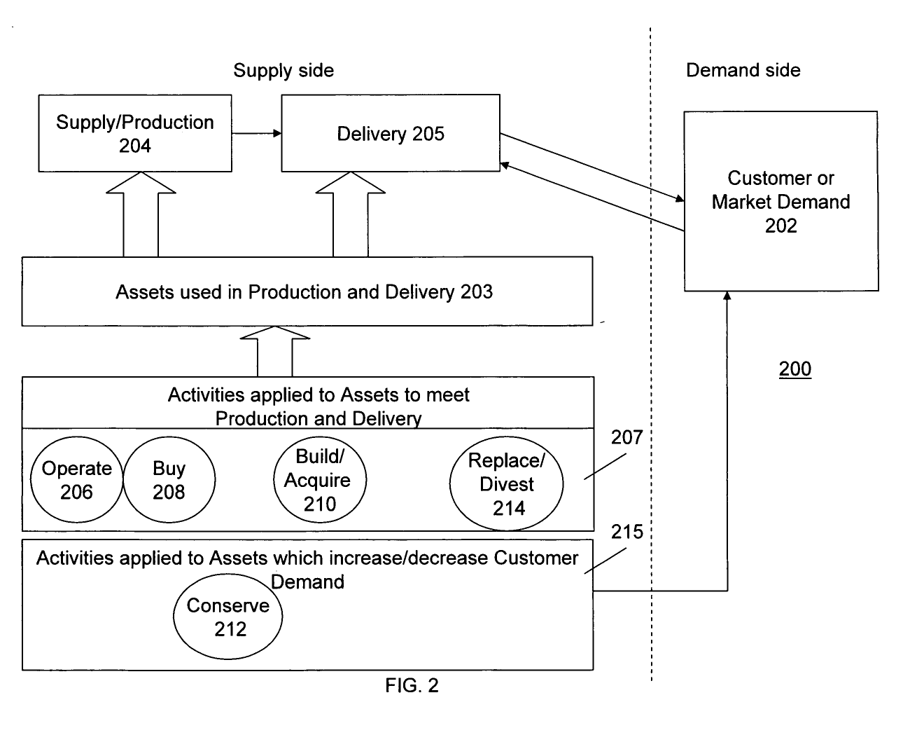

Referring now to FIG. 2 there is shown a business model 200 for representing aspects of an asset-centric planning process according to an embodiment of the present invention. The business model 200 shows how the value of assets used in production and delivery can be quantified and monetized in a varying and uncertain environment. As mentioned earlier, an asset-based business exists to support demand for a product or service from potential customers. The model 200 shows activities associated with a supply side and a demand side of the business. In conventional and accepted business terminology, the demand side of a business relates to the environment external to the operations of a business and includes processes, decisions and operations associated with generating customer demand for the output of a business. It includes the market within which a business operates and provides its products and the changes that the business can impart on its market through its decisions and investments including but not limited to, changes in product pricing, product offering and sales channels. The internal side of a business is conventionally referred to as the supply side of a business and relates to the processes, decisions and operations associated with fulfilling customer demand for the output of a business. It includes the supply chain management, asset base and supporting operations which allows a business to provide its products and the changes that the business can have on its own internal operations and supply chain market through its decisions and investments including but not limited to, changes in asset capability and operation.

Considering the supply side of the model, it may bee seen in FIG, 2 that in order to address customer demand 202 the business has two primary streams of activities, namely production 204 of product or service and delivery 205 of the produced product or service. Assets 203 are employed to generate production 204 and/or for delivery 205 and consequently businesses must review a series of options 207 regarding investment in and operation of their assets 203. These options 207 include, as appropriate for the specific business, operating 206 including maintenance activities, buying or trading product from the market 208, building or acquiring new assets 210, replacing existing assets or divesting of assets 214 or developing conservation programs 212 to modify consumer demand. The way in which businesses have evolved has resulted in this process often being fragmented within large businesses such as capital asset-intensive businesses. Generally, one group will plan independently for each of the activities (maintain, buy, build, conserve, or replace). Typically, these plans are built as a series of disconnected spreadsheets or ad-hoc databases and are not brought together until a point in time where a general ledger view is required.

A further capability of an asset-centric planning process, and a benefit of the present invention, provides for simultaneously considering customer demand investment alternatives 215 which modify customer demand 202 for the productive output of assets 203 and thereby deferring or reducing investment in the company's asset base. Such customer demand investment alternatives may include, but are not limited to, customer pricing strategies or introducing customer retention or loyalty programs.

The present invention, as utilized in asset-centric planning process 200, provides for a unified planning environment where investment alternatives, as they relate to activities 207 and 215, can be considered and their consolidated spending and impacts compared to each other and against a company's business objectives. By providing data structures that capture and relate relevant information relating to the activities 207 and 215 for each asset, and tools which facilitate direct comparison in a unified environment of investment alternatives to change customer demand 202, production 204, or delivery 206, the present invention permits companies to model and evaluate their business in a holistic manner.

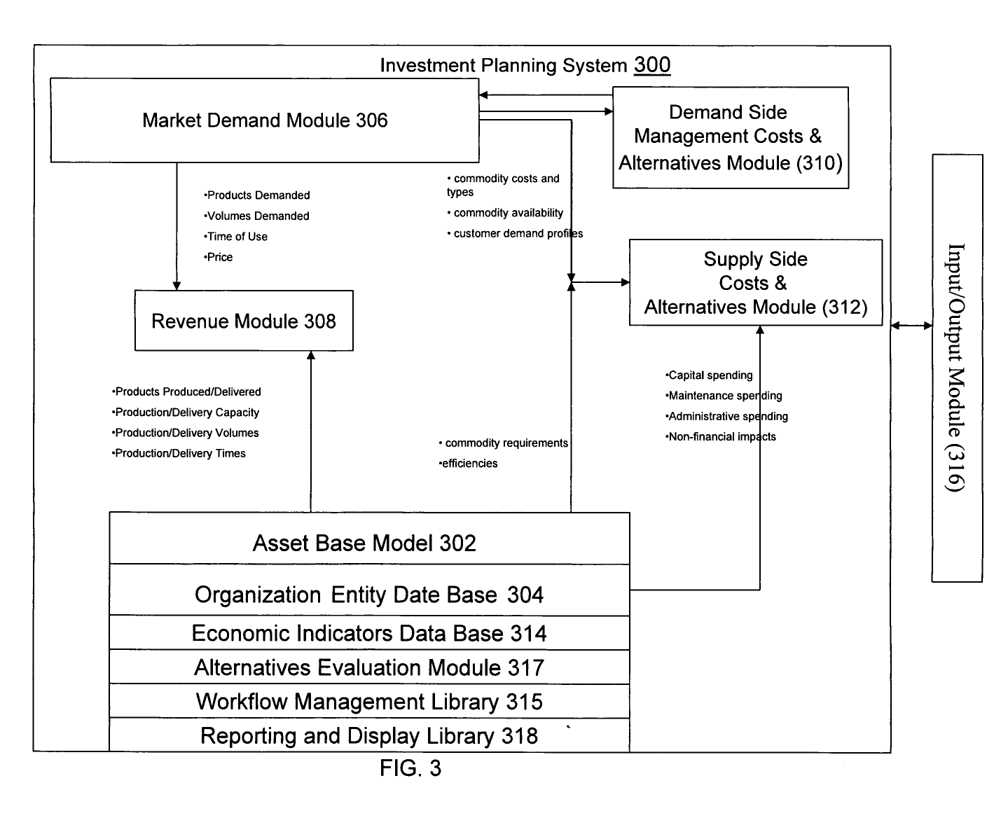

Referring to FIG. 3 there is shown a schematic diagram of an asset investment planning system 300 for implementing the asset-centric planning process according to a general embodiment of the present invention. A key to the planning system is the ability to create and store a plurality of data records termed alternatives, as will become evident from the following description. The planning system 300 includes an asset base model data structure 302, market demand forecasting module 306, revenue forecasting module 308, demand side management costs & alternatives module 310, supply side costs & alternatives module 312, organizational entity data base 304, economic indicators data base 314, alternatives evaluation module 317, workflow management library 315, reporting and display library 318, and input/output module 316 Each of these elements will be described below.

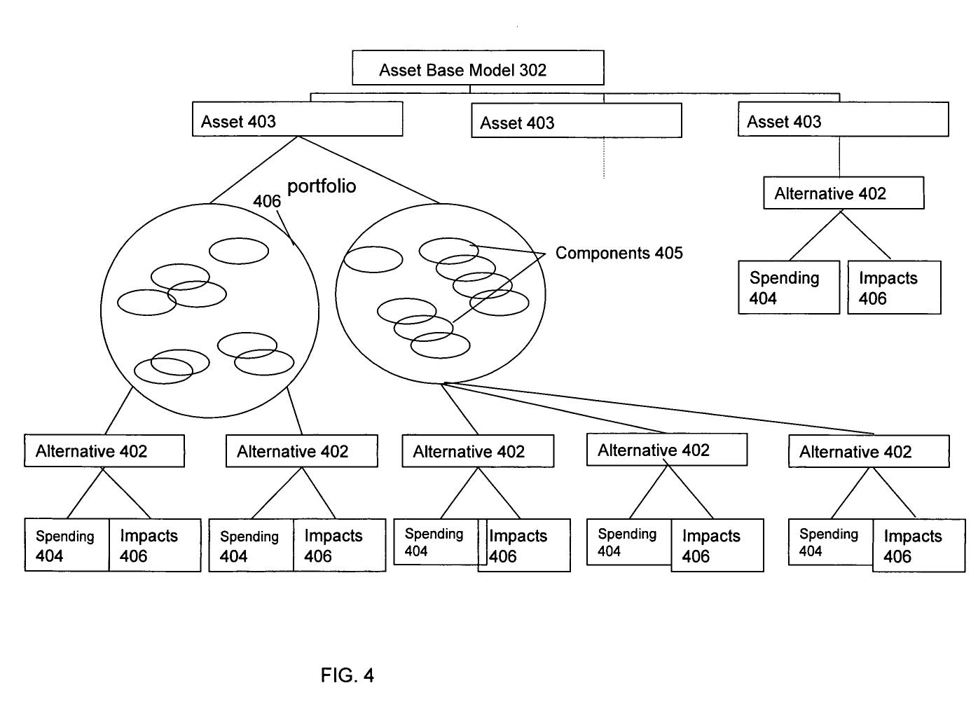

The asset base model data structure 302 is used for storing data for a collection of assets, such as equipment items, that produces or delivers product or services to generate revenues for the business. The data structure includes data for identifying relationships between the assets in the collection of assets, such that the assets may be represented in a hierarchy, may include both productive and non-productive assets and may include investment alternatives. Representative data captured in asset base model 302 includes different alternative scenarios of spending and impacts for a company's assets such as, but not limited to, financial spending on operational, capital and overhead, and all impacts be they financial or non-financial, such as productive capacity, asset life, asset age, asset condition, asset type, raw material input requirements, raw material conversion efficiency, primary products produced/delivered and secondary products produced/delivered. The Asset base model 302 is further described in subsequent FIGS. 4, 5 and 6.

The market demand forecasting module 306 includes a data structure for storing data on the types of commodities that customers want to buy, the input commodities used as raw material inputs to produce or deliver a company's products or services, commodity prices, timing of demand and volumes demanded. If this data is expected to vary over time, then several data points per data type are provided as a time series. Examples of data captured includes commodity name, customer identification, customer class, customer (class) region, customer class demanded commodity, customer (class) commodity demanded volume and time of demand (by hour, week, month and year), input commodity price forecasts and customer (class) commodity rate forecasts.

A market is a mechanism to establish price for the business' product or service and can cover the gamut of regulated to free. Advantageously, market demand forecasting module 306 of the current invention allows the prices for the business' products or services to be changed, subject to investment decisions and as may occur in a free market, and thus use of the current invention is not limited to regulated markets where pricing is generally fixed by an external regulator. To support scenario and sensitivity analytics, alternative forecasts for each of demanded volume, time of demand, price forecasts and rate forecasts can be stored. To ensure the analytics are auditable, changes to each of demanded volume and time of demand, price forecasts and rate forecasts are stored with a date, time and user identification along with previous data states stored. Functionality to support the analytics referred to here is commonly available to all modules of Planning System 300 through alternatives evaluation module 317. Examples of the analysis supported are described below in the description of alternatives evaluation module 317.

Where the planning system 300 is to be used by a company to model non-financial spends and impacts, market demand module 306 stores the market conversion factors enabling the conversion of non-financial attributes into a financial value; where spend is defined as a dollar value a company chooses to expend and impacts represent incremental costs and benefits arising from an investment alternative. Spends and impacts are further described below. These market conversion factors allow for analytics to compare non-financial and financial attributes in a common manner as is provided for by a utility function. Such market conversion factors can include but are not limited to those to relate environmental impact such as C0₂ or S0₂ emissions in tons per year to dollar-base costs, or the market value attributable to more reliable power delivery or a safer working environment. In some cases these market conversion factors will have readily ascertainable market values as the non-financial attributes have commercial markets to set their value, and in other cases these values must be selected by the user. Providing the market conversion factors is achieved through a user interface in the ret demand forecasting module 306 which captures the following data: non-financial attribute name (commodity), value nomenclature (dollars or score), forecast values over time (by hour, month and year), value forecast confidence and value forecast standard deviation. Users can enter multiple forecast cases for each non-financial attribute. To ensure the analytics are auditable, changes to each of demanded volume and time of demand, price forecasts and rate forecasts are date, time and user stamped with previous data states stored.

The revenue forecasting module (308) combines asset production/delivery forecasts together with demand forecasts and product pricing assumptions, by consolidating information from both asset base model 302 and from market demand forecasting module 306. This consolidation is performed by selecting data related to the investment alternatives under consideration from the asset base model 302, such as the total productive output capacity from the asset base, and data from the market demand forecasting module 306, such as expected demand for the output commodity of the asset base and the customer price that will be paid for this output commodity, and mathematically combining the projected supply of produced commodity with the projected prices for that produced commodity into projected revenue. Mathematical combination is the result of multiplying commodity price times output commodity volume adjusting for losses during production/delivery processes (ie: typical losses are the result of shrinkage or evaporation). Losses are calculated by incorporating input commodity conversion factors into the equation. The revenue view is the result of users requesting reports through the revenue forecasting module 308 by selecting report type, report start date, intervals reported (month, quarters or years), number of intervals, price forecast case for each product, price demand case for each product, production forecast case for the given asset or organization. Reports from the revenue forecasting module 308 can be displayed at run-time, their configurations can be saved for future recall, and their results can be exported to external spreadsheets, like Excel, for further analysis.

The demand side management (DSM) costs and alternatives module 310 provides a module whereby the user can capture data and model the alternative costs incurred by the organization as a result of choosing to modify customer demand for their product or service as a separate investment alternative.

The supply side costs and alternatives module (312) combines the costs incurred by a company as a result of choosing to meet customer demand. Supply spending can be summarized into operating, capital, maintenance and administrative spending.

Operating spending represents those variable costs that are the result of operating the assets. Operating costs are calculated at run-time by combining production/delivery forecast data from the asset base model 302 with raw material inputs conversion factors and commodity price data from market demand forecasting module 308. Users can generate reports of operating costs by selecting in the user interface of supply side costs and alternatives module (312) report type, report start date, intervals reported (month, quarters or years), number of intervals, price forecast case for each product, price demand case for each product, production forecast case for the given asset or organization. Such operating costs reports can be displayed at run-time, have their configurations saved for future recall, or be exported to external spreadsheet programs, such as Microsoft Excel, for further analysis.

Non-variable costs are those costs whose amounts, activities or timing can be separated from the variable and direct operating costs of operating an asset. Such non-variable costs can include maintenance and capital spending, and are associated with work on, or replacement of, existing equipment items under alternative investment scenarios. Maintenance and capital spending forecast summary reports can be generated by the user through an expenditures view provided for within supply side costs and alternatives module (312). These summary reports parse and consolidate data stored under alternative scenarios within asset base model 302. Data summarized in these expenditure reports includes, in addition to the summarized maintenance and capital spending, expenditures names, descriptions organizations expenditure dependencies, equipment items, and user configurable fields.

The organizational entities data base 304 includes data that represents the reporting structure of the company. The data included in the organizational area includes organizational name, definition, code, parent organization, role of organization (cost, revenue, profit, and investment), region, composite depreciation rate, headcount by job groups, and currency.

The economic indicator data base 314 stores global variables used to derive real and nominal dollar values, pro-forma financial statements and discounted cash flow analysis from the information stored and generated in planning system 300. These global variables are user configurable with minimum required information being the inflation, interest, debt/equity and overhead allocation rates. Each variable includes a name, definition, compounding factor identification, and forecast values across months and years. All data in the economic indicators entity is date, time and user stamped with previous data states stored in economic indicator data base 314 to enable recall and full auditability.

The modules include functions to allow a user to analyze and compare investment alternatives. This functionality is resident in alternatives evaluation module 317 where algorithms, libraries and reporting functionality are provided for use by other modules of planning system 300. Additionally, alternatives evaluation module 317 provides dedicated user interface screens and optimization algorithms as is known in the art to automatically identify preferred investment alternatives for the user.

The general functionality of alternatives evaluation module 317 includes but is not limited to the functionality to perform discounted cash-flow analytics, to create pro-forma financial statements, to convert non-financial attributes to a financial value or score, to perform sensitivity analysis on alternatives and thereby calculate changes in the consolidated impact and spend caused by changes in other attributes of the alternative, to parse and consolidate all alternatives under consideration then order those alternatives according to user defined criteria, and to analyze and summarize in a consolidated manner the statistical confidence of the attributes associated with an investment alternative. Algorithms to perform such analysis are commonly known in the art. Specific analytics performed by alternatives evaluation module 317 includes but is not limited to reducing all spend and impact flows to nominal dollar values using the conversion parameters stored in market demand forecasting module 306 then using discounted cash-flow techniques to provide the net present value (NPV) scores of different alternative, or group of alternative, for comparison to each other. Further analytics may include cost/benefit analysis of each or all alternatives by comparing the present valued sum of positive impacts to the present valued sum of spends and negative impacts. Once summed impacts have been determined for each alternative, said alternatives may be ordered by cost/benefit ratio, with lower cost/benefit ratio being preferred, and a sub-set of alternatives chosen and combined into a portfolio of investments wherein the combined total of a selected attribute of the sub-set, for example cash to be invested in each alternative, is less than or equal to a user-selected limit, for example the total available budget to invest. Yet further analytics can include threshold analysis to assure that an alternative does not exceed a user-specified threshold in any one or any combination to attributes.

Attribute and market values provided by the user may be subject to error or uncertainty and so an ability to perform sensitivity analysis of investment alternatives to changes in these assumptions is an element of the asset-centric planning process 200. The alternatives evaluation module 317 supports sensitivity analytics including the application of a positive or negative change to an attribute or a market parameter, for example this can be done by applying a percent increase or decrease in the attribute or parameter from its current value or its time-series set of values, and then reviewing the result of such a change on the spend and impact values of that alternative or set of alternatives being considered.

The planning system 300 advantageously includes input/output module 316 for facilitating exchange of data to and from planning system 300 and other company systems. Such data can include but is not limited to: information regarding asset hierarchies, asset production capabilities, asset maintenance and failure histories, asset conditions, market price forecasts, actual spends, organization codes, asset book values and GAL codes from a customer's G/L based accounting or transaction system, information from a customer's project management system, or information requiring off line spreadsheet analysis. All information within planning system 300 may be designated, subject to a user's authorization level, for export through input/output module 316. User authorization limits over data can be established, for example, to read only rights for all data, full read/write rights for all data, or read/write rights restrictions over data segmented by the user's organizational entity, or any such combination.

The reporting and display functions of the present system allow investment alternative attributes, including financial and non-financial spend and impact attributes, to be displayed to the user. Such reporting and display functionality is resident in commonly accessible form in reporting and display library 318, which provides for information and data resident throughout planning system 300 to be displayed both in tabular and graphical format, in stand-alone and consolidated manners, wherein said investment alternatives maybe either user-selected or automatically-selected through use of alternatives evaluation module 317. This reporting and display functionality may be computationally intensive and techniques for efficiently generating these reports is described in U.S. Provisional application No. 60/945,551 incorporated herein by reference.

The system includes he management functions for managing and tracking changes to data resident in planning system, 300. Changes in data can be date, time and user stamped, to be controlled through user-designated authorization limits, and communicated to other users for their notification, review and subsequent modification, approval or rejection. Where communication to other users is to be provided, this can be done either through notification within planning system 300 or by export of notification commands, such as email-based notifications, to other enterprise-wide tools outside of planning system 300. Such data change management functionality is resident in workflow management library 315 and is commonly available for use by all modules throughout planning system 300.

Referring to FIG. 4 there is shown an object diagram of the asset base model 302. The asset base model 302 comprises data objects for storing identifiers for a plurality of assets 403 in the asset base 203 where each asset may be further comprised of a plurality of components identified by component objects 405. Data that may be captured against components 405 and assets 403 include equipment item name, equipment item function, equipment item mode (discrete, linear or mobile), equipment item parent, original in-service date, equipment item criticality, equipment item condition, equipment item depreciation class, equipment item net book value, equipment item maintenance history, equipment item failure history, equipment item replacement forecast date, equipment item replacement cost, and equipment item risk profile. Additional data that may be captured against assets 403 includes asset definition, asset mode (discrete, linear, mobile), asset parent, and asset region. Changes to captured data are date, time and user stamped with previous data states stored to enable trend analysis against equipment items and asset systems. Components 405 can be grouped into component portfolios 406 and designated as productive or non-productive. Productive portfolios may have additional data captured against them to enable modeling of supply capabilities (production and/or delivery) where such data can include capacity, primary product names, primary product production volumes by hour, week, month and year, primary product raw material inputs, primary product raw material conversion factors, by-product names, and by-product production volumes by hour, week, month, and year.

In addition to the asset hierarchy, the asset base model includes sets of investment alternatives associated with each component 405 or portfolio or components, be they designated productive or non-productive, and possibly and additionally with each asset 403. Each investment alternative 402 comprises descriptive attribute data about the alternative as well as projections over time for both spending 404 and impacts 406 of that spending. It is notable that spending 404 includes all expenditures of cash to be made by the company and impacts 406 includes all benefits be they financial or non-financial to the company and its stakeholders that result from the considered alternative 402.

The relationship between the assets and alternatives in the asset base model may be expressed more clearly by the following hierarchy or data structure, where [ . . . ] denotes a set. The asset base is comprised of:

a set of assets [A1, A2 . . . AN], where Ai is the name of the ith asset in a set of N assets;

a set of components [Cil, Ci2, . . . Cij], where Cij is the name of the jth component in a set of J components that belong to or are associated with asset Ai;
the set of alternatives [Alti1, Alti2 . . . AltiM], where Altij is the name of the jth alternative in a set of M alternatives for a component Cxi;
each alternative is comprised of a set of attributes [Atri1, Atri2, . . . AtriK], where Atrij is the name of the jth attribute in a set of J financial and non-financial attributes (spending and impacts) for a ith spending alternative Altixk; and
each attribute has a set of values over time [Vali1, Vali2, . . . ValiP], where Valij is the jth value in a set of time periods P for the ith attribute at a time period j.

The set of values for each attribute may be financial values such as dollar values of actual spending, capital costs or similar, while the non-financial attributes may include non-financial impacts such as tons of CO₂ emission etc. In the latter case a suitable conversion values maybe stored in market demand forecasting module 306 which may be applied to globally convert these non-financial values into a dollar value for display, analysis and comparative purposes.

The spending 404 and impacts 408 attributes represent the costs and benefits of the investment alternatives projected over a timeframe up to and including the useful life of the asset or component. The collective values of these attributes define the key differences between investment alternatives to be considered. For example, one investment alternative may involve a smaller beneficial impact early in the investment, but a greater beneficial impact over time, when compared with another investment alternative offering a greater beneficial impact earlier, but a smaller beneficial impact over time. Specifically, the first investment alternative may be expected to produce a larger non-financial negative impact, such as CO₂ emissions in tons per year, in conjunction with a reduced annual maintenance spend, when compared to a second alternative which is expected to result in reduced CO₂ emissions but at a higher maintenance spend.

In addition to the projected spend 404 and impact 406 attributes, additional information may be captured at the alternative level including alternative name, alternative description, alternative cost type (maintenance or capital), recurring cycle and frequency, in-service date, depreciation rate, capitalization factors (allowance for funds used during construction), pre and post investment risk, investment alternative status, spending (by month and year), cost forecast derivation (ie: compatible units, discrete, historic adjusted for inflation), cost forecast structure (users can choose a combination of accounting codes, work break-down structures, resources and activities), cost forecast confidence, spend or impact standard deviation representative of the possible statistical deviation in forecast values from stated value, and non-financial of financial anecdotal effect on key performance indicators and approvals. All investment alternative data is date, time and user stamped for changes with previous data state stored for future recall and full auditability.

Thus the above may be represented in a database having one or more asset data structures each for storing data representing an asset of the business, the asset having an ascertainable productive output with forecastable market value; and an attribute data structure associated with each asset data structure for storing one or more attribute values corresponding to the financial and non-financial productive outputs, inputs, and associated impacts of the asset over a time period which relates to the useful productive life of the asset. Forecastable in the present context is intended to mean that the output has a market value that is predictable or that can be forecast into the future.

It maybe noted that the demand side management costs and alternatives 310 and the supply side costs and alternatives may also be defined by a similar hierarchy and data structure as the asset base model above.

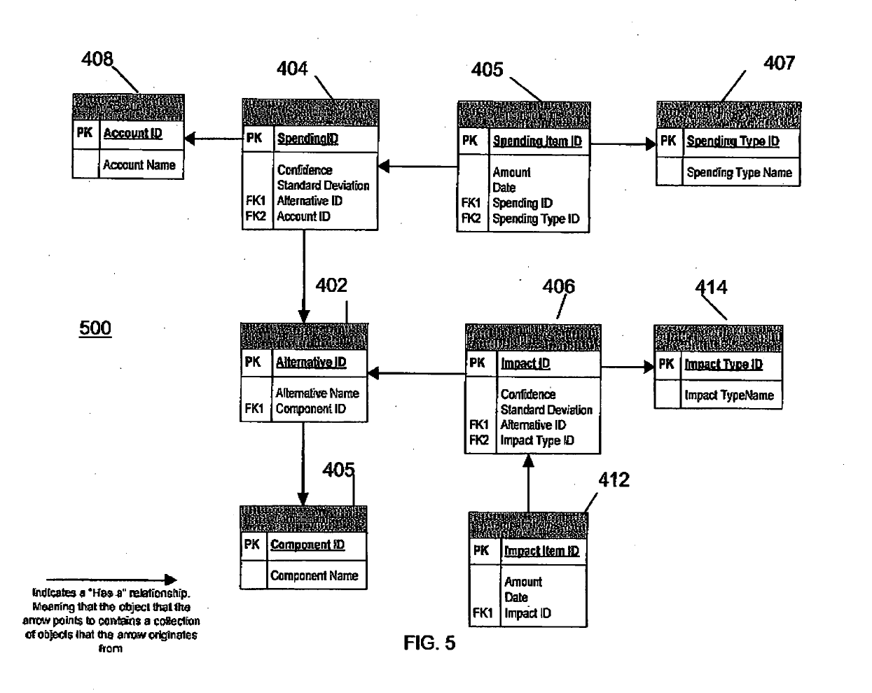

Referring to FIG. 5 there is shown an ERD 500 representing the investments alternatives data structure associated with component 405 in the asset base model 302. The component can represent a real object, such as an electrical transformer or a generator, or a virtual object like a marketing team or an intellectual property portfolio. A component table 405 is related to an alternatives table 402 where each component 405 has a plurality of alternatives 402. A spending table 404 associates with each alternative 402 a collection of projected financial costs. This is where the cost header is stored. There is one record in this table for each spend type. This table stores the selected cost type, as well as the confidence and standard deviation. A Spend Items table 405 associates with each spending 404 a collection of spending items. The spending values are unique for each time period and are stored in nominal dollars. This table contains a collection of date/amount pairs to enable representation of the cost over time. A Spend Types table 407 stores a collection of cost types that are user defined and used by the system for costs. An accounts table 408 is associated with the spending table 404 and stores a collection of accounts that are user defined and used by the system for spending. Each alternative in the alternatives table 402 has a collection of impacts which are incremental costs and benefits, financial and non-financial, incurred as a result of the spend. This is where the impact header is stored. There will be one record in this table for each impact on the user interface. This table stores the selected impact type, as well as the confidence and statistical standard deviation associated with the nominally provided value. Each impact has a collection of impact items stored in an impact items table 412. The impact values may change over time. This table contains a collection of date/amount pairs to represent the impact over time. An impact types table 414 stores a collection of impact types that are user defined and used by the system for impact. Note that non-financial impacts may be related to financial values through the application conversion factors.

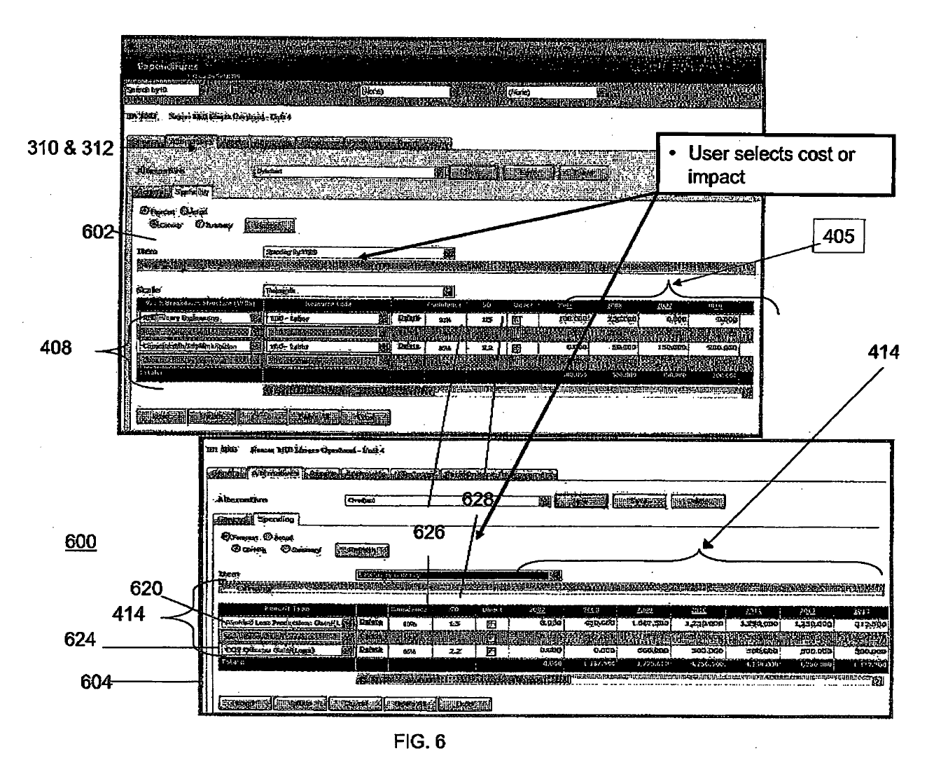

Referring to FIG. 6 there is shown a screen display 600 for a single example investment alternative based on a sample set of values retrieved from the data structure 500 of FIG. 5. The attributes of the investment alternative are shown on two screens grouped according to spending 602 and impacts 604. The spending screen 604 shows the spending that represents the money that must be spent to achieve the objectives of the alternative. The impacts shown in the screen 604 are the incremental impacts to the business as a result of deciding to proceed with the alternative. Impacts can be incremental costs or benefits. Examples include: avoided shut-downs 620, reduced maintenance, production impacts, reduced green house gas emissions 624. Confidence 626 represents the confidence in the estimate. Standard deviation 628 represents the statistically defined deviation possible for the spending or impact from the stated value, based on how reliable the information is presumed to be.

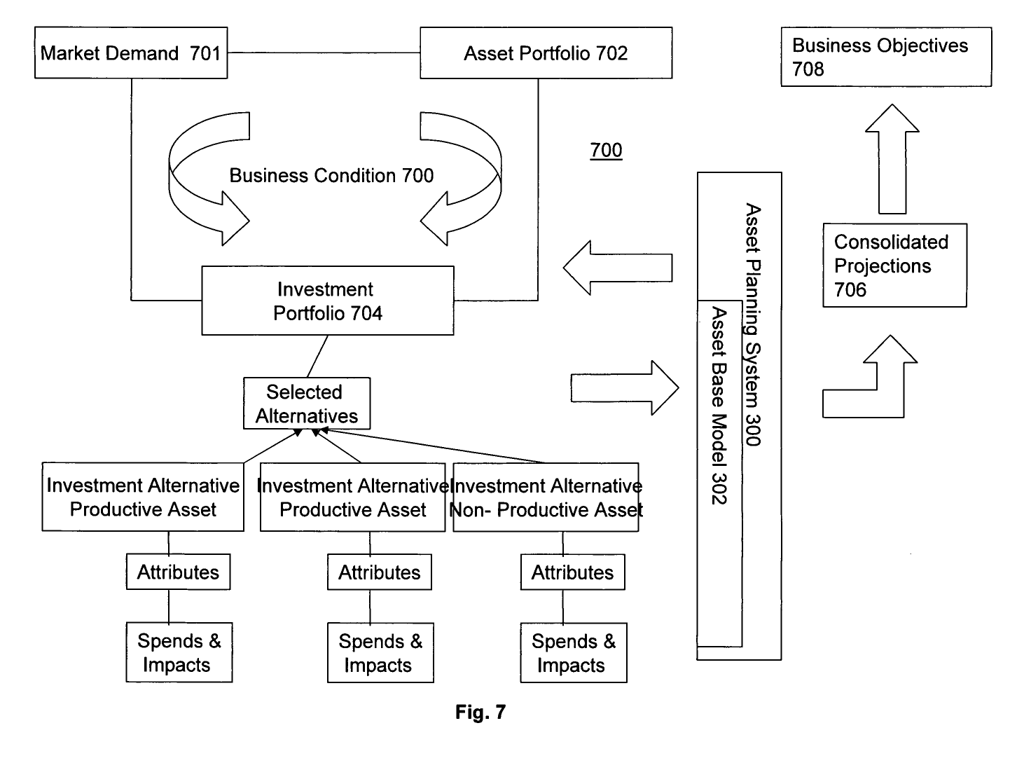

Referring to FIG. 7 there is shown a process 700 for using the asset planning system 300 illustrating how the current invention enables decisions to be derived from the asset model, which represents bow the asset base provides a business value over time relative to changing market conditions, and supports decision making over the life-cycle of the asset as opposed to the budget cycle of the business.

As has been discussed, a business exists as a dynamic system subject to changes from its external environment or its internal capabilities. There exists a need to model the business such as to allow quick and holistic understanding of the impact of these changes, to develop a portfolio of responses to these changes, and to forecast the effect of these changes and responses over time and against the objectives of the business. In most cases the portfolio of responses will involve a redeployment of a business' assets, resources or capital. If the portfolio of responses chosen appear inadequate to allow the business to achieve it objectives, then iterations are necessary considering any and all feasible alternatives.

As mentioned in FIG. 2 and now reiterated with reference to FIG. 7 a generic business condition 700 exists as a synthesis over time of the market demand 701 for the business' products and services, the asset base 702 of the business, and the planned investment portfolio 704 of the business. As previously mentioned investment portfolio 704 is comprised of selected investment alternatives, driven by the need to invest in the asset portfolio 702 or need to invest in non-physical assets (ie: marketing programs) each with projected costs and benefits. The assembly of a set of selected investment alternatives 705 results in creating an investment portfolio 704 with its consolidated cost and benefit projections. In order to select the optimal investment portfolio 704, the business condition 700 is compared to business objectives 708 over time after the expected effects of investment portfolio 704 on either or both of asset portfolio 702 and market demand 701. The business objectives 708 and consolidated value measures 706 include economic measures derived from pro-forma financial statements and discounted cash flow analysis, environmental measures derived from capturing the input/output relationships of the asset model and investment choices and social measures derived from the incremental impacts of any given expenditure, expenditure portfolio and life-cycle portfolio.

The process for selecting the optimal investment portfolio using planning system 300 may be better understood by referring to an example. Assume a company has a single productive asset such as a production plant in its asset base. Further assume that a majority of equipment items in this plant's asset base have exceeded their design life and that a number of equipment items have begun failing in the past year causing unplanned forced plant outages and loss of productive output. Assume that in the current budget cycle (i.e year 0), the plant manager puts forward budget items to replace two critical equipment items. Well known standard cost benefit analysis indicates that two critical equipment items should be replaced (i.e.: benefit cost ratios acceptable and net present value greater than zero). However, if the productive output of the asset portfolio of the plant is compared to long-run market demand of the plant's product, it is noted that the plant is not economically viable as too many equipment items require replacement. The company can now look at building a new plant or at upgrading the current plant's capacity to increase production and diversify product lines. Each of these alternatives need to be considered under varying conditions including production volumes, operating cost profiles, market pricing forecasts, etc. and an alternative selected.

Accordingly, the planning system 300 of the present invention allows a user to answer relatively complex questions quickly, such as: i) What is the impact on revenue given a change in commodity prices? ii) How sensitive is the level of new financing to a change in capital spending? iii) What if we invest more today? Will we be, more or less likely to achieve objectives in the medium and long-run? iv) What are the key variables which make the plan change substantively (e.g. customer demand, rates, fuel prices, etc.)? v) By how much can key variables change, which cause the recommended plan to change substantively?

This is better understood by considering the following.

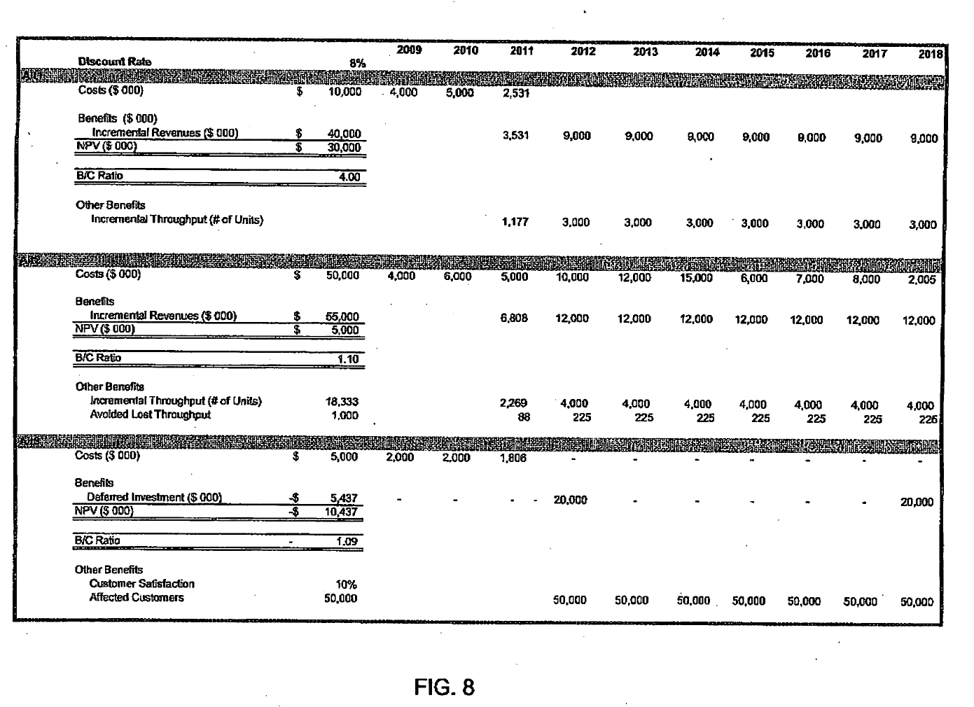

Firstly it is assumed that the asset base model is populated with appropriate data for the various investment alternatives as shown in FIG. 8. Three alternatives labelled alt1, alt2 and alt 3 are shown, each of which describes a different investment scenarios with varying economic and cost benefits.

Assume an equipment item is running inefficiently as observed by a plant manager of its its decreasing throughput. An investment alternative to replace the inefficient equipment item is reviewed for economic costs and benefits. This first alternative is referred to as Alt 1 with the following attributes: Present Value of Costs is $10 million, present value of hard benefits from increased throughput is $40 million providing a benefit cost ratio of 4:1; robust and not sensitive to changes in fundamental variables. As this investment is a pure efficiency investment (increased throughput), no other business objectives 708 are affected by this investment. Alt 1 is included as a single investment in a larger portfolio of investments 704.

The business conditions of the company 700 are such that all investments can not be funded; insufficient funds are available to complete all requested work.

There is the desire to understand whether replacing this one equipment item over the life of the entire plant is economic. A second alternative that referred to as Alt 2 is created. Alt 2 reviews all equipment items in the context of the Asset Base Model 302 to understand multi-year investment requirements into all equipment items; assume 10 years. The Asset Base Model 302 is reviewed to identify all equipment items that are beyond their useful life tolerances, beyond failure history tolerances, and experiencing increasing maintenance costs; where useful age tolerance is that percentage of age that the company deems the equipment item to be economically viable and where the failure history tolerance is that number of failures within a given timeframe for a given equipment item that the company deems unacceptable. The multi-year investment requirements are determined to be $50 million. Determination of investment requirements in the original equipment is cost adjusted for inflation and are assumed to occur at the earlier of useful age tolerance or failure history tolerance.

The forecast Market Demand 701 for all products and by-products indicated by the Asset Base Model 302 is reviewed over the same 10 year time frame. The forecast Market Demand 302 is compared against Production from the Asset Base Model 302 to determine supply/demand surpluses or deficits. It is noted that Market Demand exceeds production capabilities; there is a market deficit and all products produced will be demanded by the market; no production surpluses/wastage. The forecast Market Demand 302 prices are used to determine a Revenue Model and Operating Cost model by multiplying Asset Base Model 302 production volumes by Market Demand prices for both input and output commodities adjusted for conversion factors.

The second alternative Alt 2 is evaluated in the context of the 10 year the Revenue Model, the 10 year Operating Costs and the 10 year investment requirements. The result is a Net Present Value of $5 million for a benefit cost ratio of 1.1:1. Alt2 is determined to be highly sensitive to any change in any assumption. Alt2 results in additional benefits consistent with Business Objectives 708 in that it increases reliability due to replacing all equipment items avoided outages resulting from critical equipment failures is imputed from the Asset Base Model 302. Alt2 results in an avoided lost production to be considered when determining which investment alternative should be pursued. Assume lost production over time results in increasing available product by 1,000 units over ten years.

Thus it may be seen that depending on the business objectives, the first investment alternative alt1 may be superior to the second investment alternative alt2. In that if the business objective is to find the minimal cost investment then it may be seen that alt1 has superior benefit cost ration. If the business objective is absolute benefit then alt2 may be better since it may be seen that its incremental cost/benefit and throughput over a time period is higher.

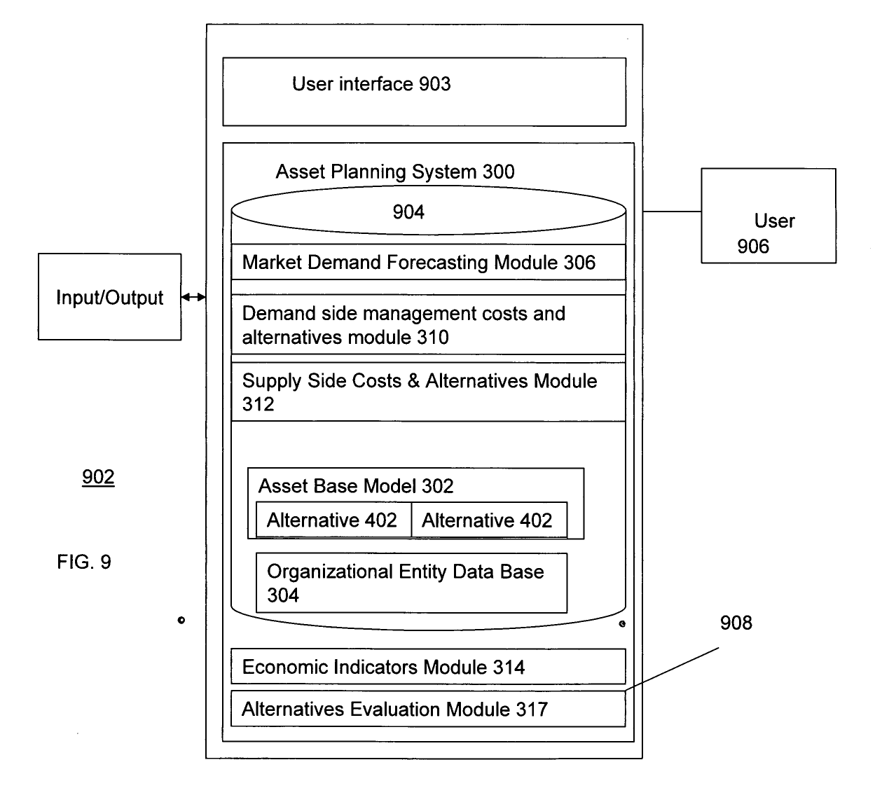

Referring to FIG. 9 there is shown a computer system 902 for implementing an investment planning system 300 according to an embodiment of the invention. The computer system 902 includes a storage device 904, a user interface module 903 and modules 908 for implementing methods of the investment planning system 300. The modules and functions may be implemented via computer instructions (e.g., one or more software applications) executing on a server, or alternatively, on a computer device, such as a user system 912. If executing on a server, the user system 912 may access the features of the system 902 over a network (not shown). A data input output module 910 allows the system 902 to interface with a business's financial and data warehouse and other computer systems. Included with the input/output module is email notification and communication functions for communication of results and reporting to various managers and users within a business to allow for easy collaboration between departments. For example the present invention allows workflow for the investment process to be managed at various steps in the process. This is in conjunction with the auditing function allows each step to be delegated if need while being monitored. The user system may be implemented using a general-purpose computer executing one or more computer programs for carrying out the processes described herein. The user system may be a personal computer (e.g., a laptop, a personal digital assistant) or a host attached terminal. If the user system is a personal computer, the processing described herein may be shared by the user system and the host system server (e.g., by providing an applet to the user system). User system may be operated by project team members or managers of the provider entity. Various methods of implementing the prediction and optimization functions may be employed as described further herein. Furthermore the database may also be implemented in a client server architecture and is preferable a relational database.

The storage device 904 may be implemented using memory contained in the user system or host system or it may be a separate physical device. The storage device is logically addressable as a consolidated data source across a distributed environment that includes a network. Information stored in the storage device may be retrieved and manipulated via the host system and may be viewed via the user system.

As described above, the embodiments of the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives or any other computer readable storage medium, wherein, when the computer program code is loaded into and executed by a computer, the computer becomes an apparatus for practicing the invention.

An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The technical effect of the executable code is to facilitate prediction and optimization of model-based assets.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims.

We claim:

1. A system for modeling a plurality of assets in a business, the system comprising:
(a) a database having one or more asset data structures each for storing data representing an asset of the business, the asset having an ascertainable productive output with forecastable market value; and
(b) an attribute data structure associated with each asset data structure for storing one or more attribute values corresponding to the financial and non-financial productive outputs, inputs, and associated impacts of the asset over a time period which relates to the useful productive life of the asset.

2. A system as defined in claim 1, said data structure comprising a hierarchy of similarly described components wherein the market value of the productive output of the components may not be ascertainable and predictable.

3. A system as defined in claim 2, said data structure comprising at least two alternative scenarios of cost and benefit to be compared.

4. A system as defined in claim 1, said attributes including probabilistic information regarding the asset.

5. A system as defined in claim 1, said attributes including data representing investments in modifying the demand for the productive output of the asset.

6. A system as defined in claim 1, including an interface for inputting data from and transmitting data to other enterprise systems.

7. A system as defined in claim 1, said attributes being selected according to one or more of: value of output, reliability, risk, environmental impact, regulatory requirements or rate of return on capital.

8. A system as defined in claim 1, said financial and non-financial information are related together through a utility function.

9. A system as defined in claim 1, wherein changes to data are stored for retrieval and audit.

10. A system as defined in claim 1, including workflow tools for the collaborative development, review, approval and amendment

11. A system as defined in claim 10, said workflow tools include email notification eternal to the system.

12. A system for analyzing an investment decision comprising a an asset model as defined in claim 1, said system including algorithms for ascertaining consolidated value and cost of the plurality of assets, where financial, non-financial, or some combination of financial and non-financial values and costs are considered.

13. A system as defined in claim 12 wherein the analysis is through pro-forma financial statements as well as discounted cash flow techniques.

14. A system as defined in claim 12, including algorithms for optimizing the value of the asset for a given cost.

15. A system as defined in claim 12, including algorithms for testing sensitivity of an optimal output to changes in the attributes of the assets.

16. A method for generating a model for productive assets in an business, the model representing financial and non financial assets of the organization, the method comprising the steps of:
storing in a database having one or more asset data structures data representing an asset of the business, the asset having an ascertainable productive output with forecastable market value; and
relating in the data structure one or more attribute values corresponding to the financial and non-financial productive outputs, inputs, and associated impacts of the asset over a time period which relates to the useful productive life of the asset.
